(19) United States
(12) Patent Application Publication
(10) Pub. No.: US 2021/0136062 A1
(43) Pub. Date: May 6, 2021

(54) Form based biometric data collection and authentication

(71) Applicant: Michael Fitzgerald, Winchester, MA (US)

(72) Inventor: Michael Fitzgerald, Winchester, MA (US)

(21) Appl. No.: 16/673,642

(22) Filed: Nov. 4, 2019

(51) Int. Cl. H04L 29/06

(52) U.S. Cl. CPC H04L 63/0861

(57) ABSTRACT

A biometric data collection and authentication system which validates the user of a dynamically generated and customizable internet form. The system may be used to generate biometric data from fingerprints, retinal scans, and voice-prints. It utilizes a client side biometric collection tool to allow verification against an existing database, or assign a unique identifier for future verification. It also has the ability to parse biometric information on to user provided or created documents.

### BACKGROUND OF THE INVENTION

### 1. Field of the Invention

The present invention relates to biometric data. More specifically, the invention relates to form based biometric data collection, merging, and authentication.

### 2. Description of the Prior Art

The use of biometric data to authenticate users in a computing environment is well known. Systems using biometric data use various algorithms to encode, store, transmit, and validate data related to, for example, the unique physical parameters of a user such as fingerprints or retinal scans. These systems are especially useful for electronic transactions where user validation is critical.

Typical of these systems is that shown in U.S. Pat. No. 8,953,851, which discloses a biometric user authentication method and computer program product includes receiving asserted user credentials from a user into a biometric authentication system, and obtaining a digitally-stored image key and ocular biometric data both associated with the asserted user credentials from memory within the biometric authentication system. The biometric authentication system is verified by simultaneously displaying the image key and at least one image other than the image key to the user and detecting that the user has selected the image key. The user is authenticated by scanning an eye of the user to obtain ocular biometric data and matching the scanned ocular biometric data to the digitally stored ocular biometric data. If the biometric system is verified and the user is authenticated, then the user is provided access to a protected area.

While this application is effective at encoding, storing, and authenticating the biometric data, it is a standalone application which may be associated with another application, but is separate from any other electronic data processing application such as form generating or banking. Accordingly, it is desirable to provide a dynamic, form based biometric data collection and authentication system.

A biometric data collection and authentication system which validates the user of a dynamically generated and customizable internet form. The system may be used to generate biometric data from fingerprints, retinal scans, and voice-prints. It utilizes a client side biometric collection tool to allow verification against an existing database, or assign a unique identifier for future verification. It also has the ability to parse biometric information on to user provided or created documents.

### SUMMARY OF THE INVENTION

It is a major object of the invention to provide a biometric data collection and verification system.

It is another object of the invention to provide a biometric data collection and verification system which is form based.

It is another object of the invention to provide a biometric data collection and verification system which can dynamically add biometric data to a form.

It is another object of the invention to provide a biometric data collection and verification system that can integrate client side generated biometric data through a form building tool.

It is another object of the invention to provide a biometric data collection and verification system which can be integrated with other applications to dynamically collect, verify, and authenticate user generated biometric data.

### BRIEF DESCRIPTION OF THE DRAWINGS

FIG. 1 is a diagrammatic illustration of the system of the invention.

### DETAILED DESCRIPTION OF THE PREFERRED EMBODIMENTS

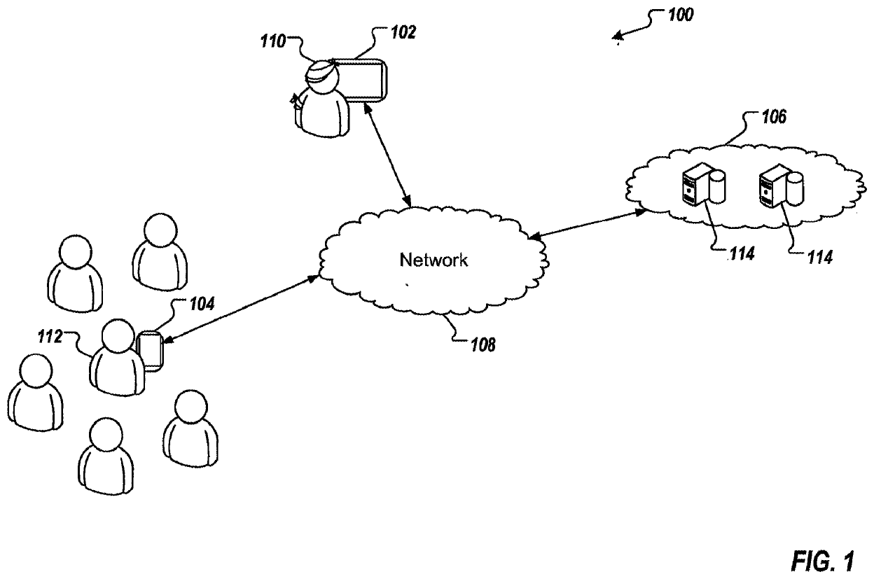

FIG. 1 depicts an example environment 100, in which implementations of the present invention disclosure can be provided. The example environment 100 enables a user to securely log into an account using a computing device. The example environment 100 includes computing devices 102, 104, a back-end system 106, and a network 108. In some examples, the computing devices 102, 104 are used by respective users 110, 112 to log into and interact with the back-end system 106 over the network 108.

In the depicted example, the computing device 102 is provided as a tablet computing device, and the computing device 104 is provided as a smartphone. It can be appreciated however, that implementations of the present disclosure can be realized with any appropriate computing device (e.g., smartphone, tablet, laptop computer, desktop computer). In some examples, the network 102 includes a local area network (LAN), wide area network (WAN), the Internet, or a combination thereof, and connects web sites, user devices (e.g., computing devices 102, 104), and the back-end systems (e.g., back-end system 106). In some examples, the network 108 can be accessed over a wired and/or a wireless communications link. For example, mobile computing devices, such as smartphones can utilize a cellular network to access the network 108.

In the depicted example, the back-end system 106 includes at least one server system 114. In some examples, the at least one server system 114 hosts one or more computer-implemented services that users can interact with using computing devices. For example, the computing device 102, 104 can be used to communicate with a service hosted by the back-end system 106 over the network 108. In some examples, the computing device 102, 104 includes a computer-executable application executed thereon, which can be used to log into the service and establish a communication session between the computing device 102, 104 and the back-end system 106. In some examples, the computing device 102, 104 includes a web browser application executed thereon, which can be used to display one or more web pages of the service, the user interacting with the service through the web page(s).

In order to obtain the biometric data, it must first be collected by scanning, photographing, or by the use of a transducer such as a microphone and associated signal processing circuitry. This may be done by the computing devices 102, 104 themselves, or by devices connected to the computing device 102, 104, said device capable of transmitting electronic data to said devices. The type of biometric data that can be used to generate a unique digital signature corresponding to a particular user includes, but is not limited to, fingerprint data, retinal scan data, or voice print data.

The software for effecting the system of the invention is, partially, on an application stored on computing devices 102, 104, and partially on servers 114 in the form of an application or specific subroutine. The application is responsible for processing the collected biometric data in accordance with the inventive system, the processing resulting in a unique digital identifier. The digital identifier is encoded and encrypted using a proprietary algorithm so that it can be recognized by servers 114.

Servers 114 may be e.g., computers associated with a financial institution. The servers would have an application stored thereon to receive and process both form and biometric data sent by users via computing device 102, 104 over the network. In a key aspect of the invention, form data and biometric data are merged so that authentication of the user by the biometric data is processed along with the form data. Form data may include the user name, SSN or other user data; but will also include transactional data associated with, e.g., a transaction the user is attempting such as depositing a check. As the transactional data, the form data, and biometric data are merged, the actual biometric data used to effect the transaction is saved after the transaction is completed, which is not possible with prior art systems. Also, as biometric data can include more than one type of data (e.g., fingerprint data or retinal scan data) the inventive system, the user's device 102, and servers 114 can save more than one unique identifier for each user, and use them on a rotating basis as will be discussed in more detail below.

The system operates by first collecting biometric data from the user via device 102, 104 or other means as described above. This data, which may be fingerprint data, retinal scan data, or other biometric data, is then digitized, encrypted, and stored on the device 102, 104. The user may store more than one type of biometric data, which (in a way) effectively gives the user multiple passwords. The user then enters the transactional data and completes the form required to e.g. effect a deposit by typing or dictating data to be inserted into a form. The fingerprint data is then merged with the transactional data for transmission to servers 114, which recognize the merged data as both transactional and biometric data. This aspect of the present inventive method is not shown or discussed in the prior art. With prior art methods the biometric data is analogous to a password, the data is not merged with the form, and once the user (or hacker) enters the biometric data they have access to the account. With the present invention, the data is merged with all forms submitted for processing and does not need to be entered to initiate the transaction. The servers 114 then process the merged biometric data to determine both if the user submitting the form is authorized to effect the transaction and if the form itself is authentic, and authenticates the form and therefore the user, if appropriate. The transactional data is then processed to complete the transaction. As the form data is automatically merged with biometric data stored on the user's device 102, and the user may store more than one type of biometric data, the inventive system may randomly choose which biometric data to merge with the form prior to initiating the transaction. This random selection of biometric data would have to be coordinated between user device 102 and servers 114 in a manner well known to those of skill in the art. Thus, a type of rotating password is generated, and any hacker/unauthorized user would have to have all of the user's biometric data in order to effect repeated transactions.

It is to be understood that the present invention is not limited to the sole embodiment described above, but encompasses any and all embodiments within the scope of the following claims:

I claim:

1. A method of using biometric data to effect a transaction comprising the steps of:
collecting biometric information from a user input device and encoding and encrypting said information to produce at least one digital signature particular to said user, and storing said digital signature on said user input device;
providing a digital form for said user to enter transactional data and encrypting said transactional data;
integrating said digital signature with said transactional data to produce combined form data for said digital form;
transmitting said combined form data to a remote server to process said transaction;
whereby said server will evaluate said biometric data to effect authentication of said form.

2. The method of claim 1 wherein said biometric information includes more than one type of biometric information.

3. The method of claim 1 wherein said biometric information is a digitized fingerprint.

4. The method of claim 1 wherein said biometric information is a digitized retinal scan.

5. The method of claim 1 wherein two or more digital signatures are stored on said user input device.

6. The method of claim 5 wherein one of said digital signatures is randomly chosen for integration with said transactional data.
